(19) United States
(12) Patent Application Publication
(10) Pub. No.: US 2008/0244144 A1
(43) Pub. Date: Oct. 2, 2008

(54) HAND-HELD REMOTE CONTROL FOR ELECTRONIC ENTERTAINMENT APPLIANCE

(75) Inventor: Wai Shun Choi, Hong Kong SAR (CN)

Correspondence Address: LEYDIG VOIT & MAYER, LTD, 700 THIRTEENTH ST. NW, SUITE 300, WASHINGTON, DC, 20005-3960, US

(73) Assignee: HOUSE BRANDS PLUS LIMITED, Central, Hong Kong SAR (CN)

(21) Appl. No.: 12/059,074

(22) Filed: Mar. 31, 2008

(30) Foreign Application Priority Data
Mar. 29, 2007 (HK) 07103388.7

(51) Int. Cl. G06F 13/00

(52) U.S. Cl. 710/303

(57) ABSTRACT

A hand-held remote control includes an emitter for emitting a control signal recognizable by an entertainment appliance. The housing of the remote control includes a longitudinally-extending recess for receiving a portable media player. A first interface device within the recess communicates with a second interface device of the portable media player when the portable media player is received in the recess. An electromagnetic radiation transmitter is disposed within the housing for transmitting data received from the first interface device.

### TECHNICAL FIELD

The present invention relates to remote controls for electronic audio and audio-visual entertainment appliances such as stereos, televisions, etc., and, more particularly, relates to an improved remote control having the capacity to remotely select media to play on the entertainment appliance from a portable media player.

### BACKGROUND OF THE INVENTION

Portable media players are well known in the art. These players include MPEG (MP3) players and are usually pocket size devices that can store hundreds of songs, photos, videos, or other media in a small space and play the same back when desired. The media, songs, photos or the like are stored on a built in hard drive memory card, removable storage or the like. A control panel is built into the front panel of the player and earphones or headphones are typically used to listen to the media player device.

Many users of portable media players would prefer to use a larger scale, or higher quality, entertainment appliance for playing back the media from their portable player when such an appliance is available, as it may be, for instance, in their homes. It is known in audio equipment capable of playing the media format, such as a CD player, to include a docking station providing a convenient interface for transferring data between the portable media player and the CD player. The docking station includes a cavity in the housing of the CD player of a complementary size and shape to the portable media player and within which the portable media player is received. A connector in the cavity engages a port of the portable media player, the connector being coupled to the CD player through a cable so that communications between the portable media player and the CD player can take place.

While the ubiquitous remote control can be used for controlling the basic functions for such entertainment appliances, there is a need to provide the ability to remotely select media to play in the same manner as is achieved using the front control panel of the portable media player. Many existing remote controls incorporate and provide a large array of buttons, functions and features which present quite a challenge to a new user. It would therefore be advantageous if this need could be met by providing the user with a familiar remote control interface, enabling the user to master its working and functionality without having to resort to complex and lengthy manuals or spending time to study the remote control. It is an object of the present invention to meet this need or more generally to provide an improved remote control for electronic entertainment appliances.

### DISCLOSURE OF THE INVENTION

According to one aspect of the present invention there is provided a hand-held remote control for an entertainment appliance comprising:

a housing having a front side;

an electromagnetic radiation emitter disposed within the housing for emitting a control signal recognizable by the entertainment appliance;

a first keyboard having a plurality of manually depressible function keys located on the front side;

a printed circuit board positioned inside the housing, the printed circuit board being responsive to contact with at least one of the manually depressible function keys for correspondingly actuating the electromagnetic radiation emitter;

a recess in the housing for receiving a portable media player;

a first interface device within the recess, wherein the portable media player includes a second interface device such that the first and second interface devices communicate with each other when the portable media player is received in the recess, and

an electromagnetic radiation transmitter disposed within the housing for transmitting data received from the first interface device.

Preferably the housing is elongate, the recess having a mouth at a longitudinal end of the housing, the portable media player being moved substantially in a length-wise direction relative to the housing when inserted or removed from the recess.

The front side is preferably planar and the recess has an axis substantially parallel to the front side.

The recess has an inner end bounded by opposing front and back walls, joined by opposing side walls, the front side being an outwardly facing side of the front wall, an outer end of the recess being bounded by the back wall, the side walls, and a lip fixed to each side wall extending generally parallel to the back wall. In this manner the mouth of the recess extends into the front side of the housing between the lips. Preferably the mouth includes a concave portion extending between the lips.

Preferably the interface devices are embodied as electrical contacts. Optionally the interface devices may be of a non-contact type such as inductors.

The electromagnetic radiation emitter preferably comprises an infrared LED. The electromagnetic radiation transmitter preferably comprises a radio transmitter.

In another aspect the invention provides a system for remotely controlling an entertainment appliance and remotely selecting media to play on the entertainment appliance from a portable media player, the system including a hand-held remote control for the entertainment appliance and a charging station, the hand-held remote control comprising:
a housing having a front side;
a compartment within the housing for receiving rechargeable batteries for powering the remote control;
an electromagnetic radiation emitter disposed within the housing for emitting a control signal recognizable by the entertainment appliance;
a first keyboard having a plurality of manually depressible function keys located on the front side;
a printed circuit board positioned inside the housing, the printed circuit board being responsive to contact with at least one of the manually depressible function keys for correspondingly actuating the electromagnetic radiation emitter;
a recess in the housing for receiving a portable media player;
a first interface device within the recess, wherein the portable media player includes a second interface device such that the first and second interface devices communicate with each other when the portable media player is received in the recess, and
an electromagnetic radiation transmitter disposed within the housing for transmitting data received from the first interface device as a data signal, and

the charging station, comprising:
an enclosure;
a cavity in the enclosure for receiving the remote control;
a mains power input;
a battery charger in the cavity, the battery charger connected to the power input for charging the batteries;
a receiver in the enclosure for receiving the data signal, and
an output electrically connected to the receiver for transmitting the data signal whereby a connector coupling the output to an input on the entertainment appliance for receiving a signal from an external source, thereby allows the transmission of data from the media player to the entertainment appliance.

This invention thus provides a hand-held remote control which not only allows the user to control the operation of an entertainment appliance in the known manner, but which also provides the ability to remotely select and play media from a portable media player. By using the front control panel of the portable media player to remotely select and play a familiar operating interface is provided to the user, avoiding a need to master a different interface such as may be required if the portable media player itself was remotely controlled by the user.

### BRIEF DESCRIPTION OF THE DRAWINGS

Preferred forms of the present invention will now be described by way of example with reference to the accompanying drawings, wherein:

FIG. 1 is a pictorial view of a first embodiment of the remote control of the invention;

FIG. 2 is a front view of the remote control of FIG. 1;

FIG. 3 is a side view of the remote control of FIG. 1;

FIG. 4 is a section along line A-A of FIG. 2;

FIG. 5 is a top view of the hand-held remote control of FIG. 1;

FIG. 6 is a bottom view of the remote control of FIG. 1;

FIG. 7 is a block diagram showing the construction of the hand-held remote control of FIG. 1;

FIG. 8 is a block diagram showing the construction of a charging station for use with hand-held remote control of FIG. 1;

FIG. 9 is a top view of the charging station of FIG. 8;

FIG. 10 is a front view of the charging station of FIG. 9;

FIG. 11 is a side view of the charging station of FIG. 9;

FIG. 12 is a back view of the charging station of FIG. 9;

FIG. 13 is a front view of a second embodiment of the remote control of the invention;

FIGS. 14-18 are rear, right side, left side, top and bottom views respectively of the remote control of FIG. 13, and

FIG. 19 is a pictorial view of the remote control of FIG. 13 showing the battery compartment cover and closure removed.

### DESCRIPTION OF THE PREFERRED EMBODIMENTS

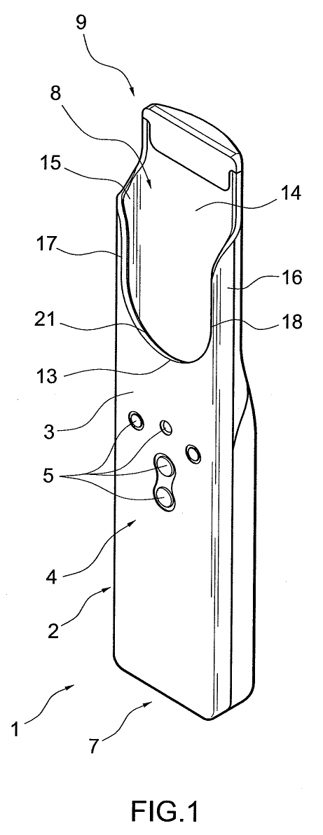

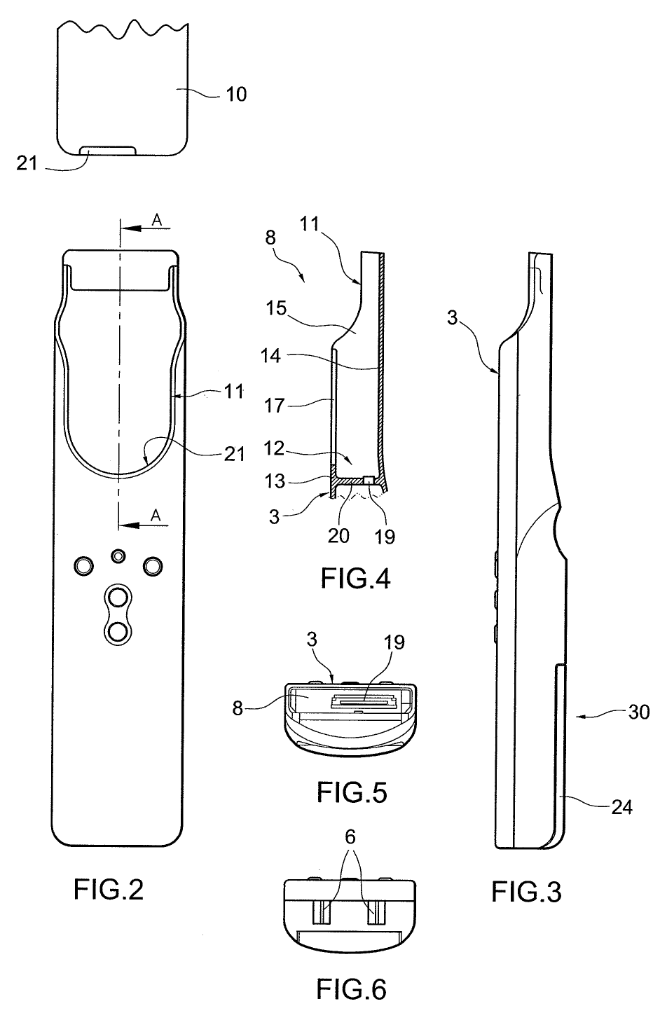

Referring to FIGS. 1-6, a first embodiment of a hand-held remote control 1 for an entertainment appliance includes a housing 2 having a front side 3 upon which a keyboard 4 is provided, the keyboard including a plurality of manually depressible function keys 5. The housing 2 is elongate having battery-charging contacts 6 at a lower longitudinal end 7 and in the opposing end 9 is a recess 8 for receiving a portable media player 10.

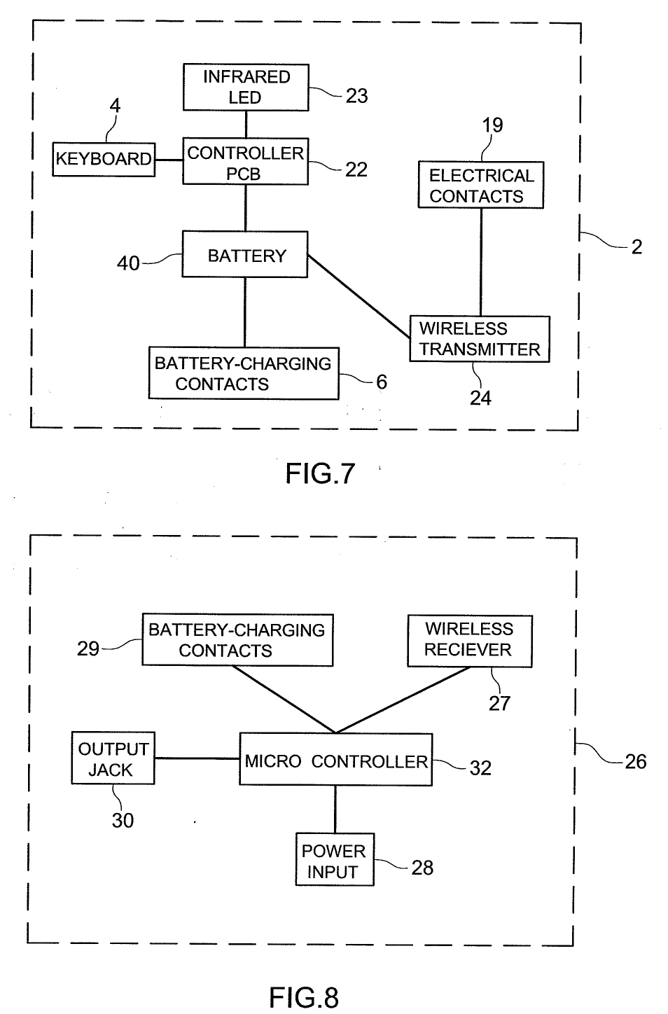

A battery compartment cover 24 closes a compartment within the housing 2 for receiving rechargeable batteries 40 (see FIG. 7). The battery compartment cover 24 is formed in a rear side 30, opposing the front side 2.

The recess 8 has a mouth 11 opposite a closed inner end 11. The inner end 12 is bounded by opposing front and back walls 13, 14 joined by opposing side walls 15, 16. The front side 3 is an outwardly facing side of the front wall 13. At the outer end 8 the recess is bounded by the back wall 14, the side walls 15, 16, and lips 17, 18 fixed to the side walls 15 and 16 respectively. Each lip 17, 18 is formed integrally with the front wall 13, the mouth 11 extending between the lips 17, 18 with a concave portion 21.

Within the inner end 12 a first interface device is provided in the form of electrical contacts 19 received in an aperture in the floor 20. The portable media player 10 includes a second interface device in the form of electrical contacts 21. The end of the media player 10 with the contacts 21 is entered into the mouth 11 and moved substantially in a length-wise direction until the corresponding contacts 19, 21 abut.

As shown schematically in FIGS. 7 and 8, the housing 2 encloses a controller printed circuit board (PCB) 22 behind the keyboard 4. Connected to the PCB 22 is an electromagnetic radiation emitter in the form of an infrared LED 23. The PCB is responsive to contact with at least one of the manually depressible keys 5 for correspondingly actuating the LED 23 for emitting a control signal recognizable by an entertainment appliance (not shown).

The battery 40 is coupled to the battery-charging contacts 6, to the PCB 22 and to a wireless transmitter 24. The transmitter 24 is connected to the electrical contacts 19 and thereby receives and transmits data received fro the portable media player 10.

In one embodiment of the invention (not shown), the hand-held remote control 1 may use the wireless transmitter 24 for transmitting data received from the portable media player 10 to a receiver integral with an entertainment appliance, such as a CD player allowing, for instance, media such as audio stored on the portable media player 10 to be played using the CD player. For use with an entertainment appliance without an integral wireless receiver, the hand-held remote control 1 may be used with a separate receiver which may be coupled to it, for instance to the audio input. A system providing this functionality includes a charging station 25. The charging station 25 includes an enclosure 26 holding a wireless receiver 27, as well as a mains power input socket 28 and battery-charging contacts 29, allowing it to also be used for charging the batteries 40. A microcontroller 32 controls battery charging and the transmission of the data signal and is connected to the battery-charging contacts 29, the wireless receiver 27 and an output jack 30. A cable connector (not shown) may be used for coupling the output jack 30 to an input on the entertainment appliance for receiving a signal from an external source. In this manner data is transmitted from the media player to the entertainment appliance.

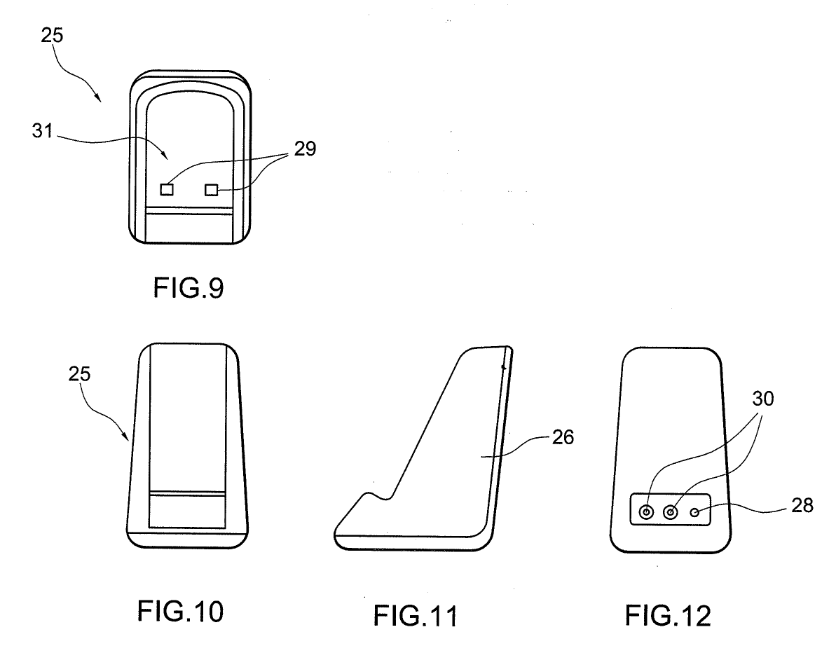

FIGS. 9-12 illustrate the charging station 25 having an enclosure 26 in which a cavity 31 is formed for receiving the hand-held remote control 1 for charging. The charging contacts 29 are spaced apart in the base of the cavity 31 for engaging the battery-charging contacts 6 of the remote control 1.

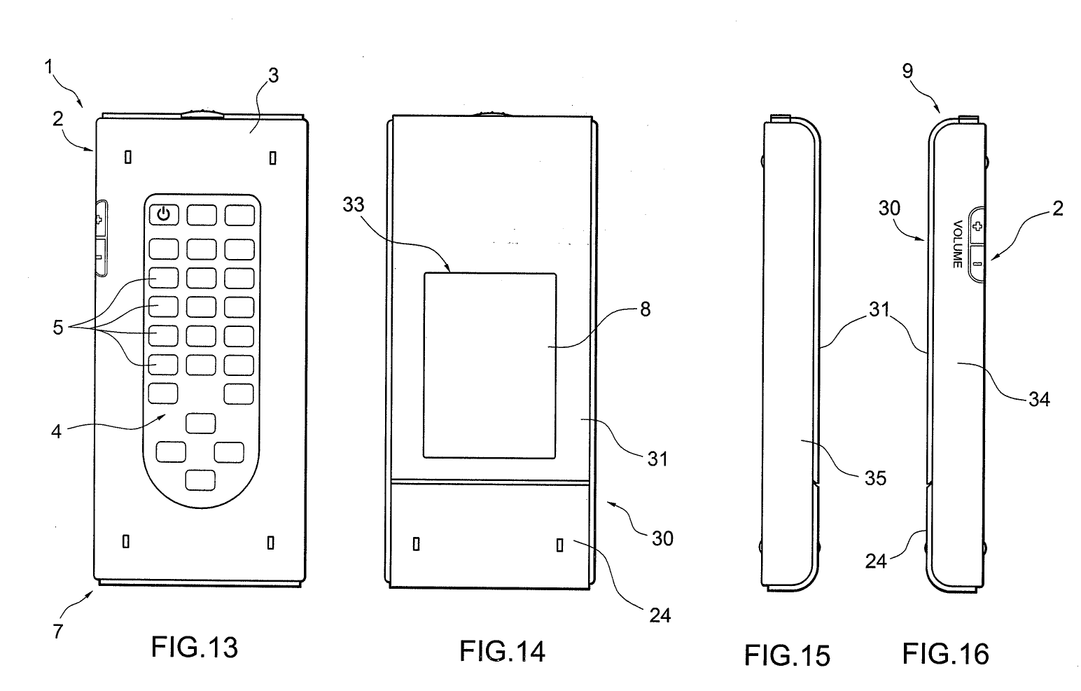

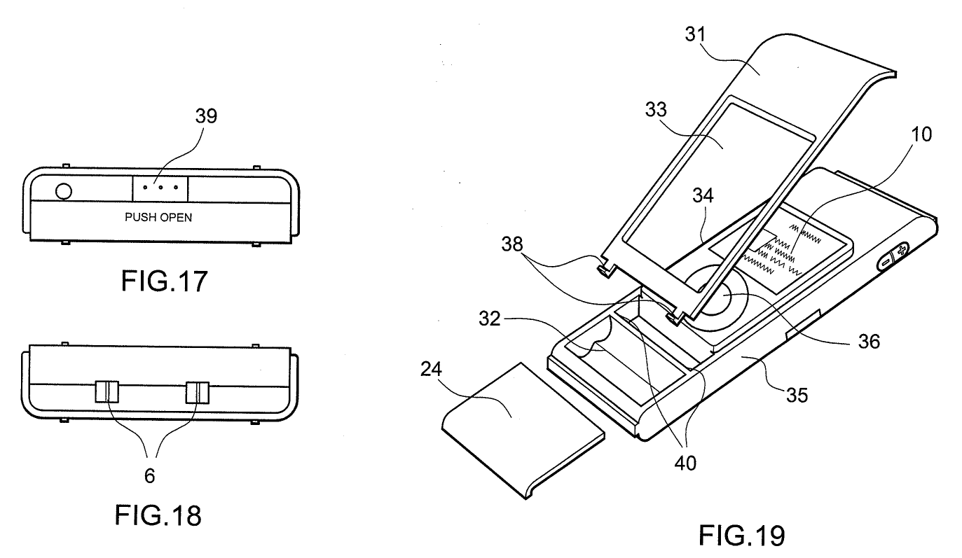

Referring to FIGS. 13-18, a second embodiment of a hand-held remote control 1 is of generally like construction to the first embodiment, and like numbers are used to referrer to like components in the two embodiments. As in the first embodiment, electrical contacts 19 are provided in the recess 8 for connection to the player 10. The second embodiment further includes a closure 31 for closing the recess 8 to retain the media player 10. The player-receiving recess 8 and battery compartment 32 are formed adjacent one another The player-receiving recess 8 and battery compartment 32 are bounded transversely between the relatively narrow and parallel sides 34, 35 of the housing which extend between the opposing front and rear sides 2, 30. The closure 31 spans transversely over the sides 34, 35 and has a through-extending aperture 33 therein through which the controls 36 of the media player 10 may be accessed. A pair of longitudinally extending tabs 38, one on either side of the lower end of the closure, is provided for engaging fixtures 40 projecting inwardly from the walls 34, 35. Alternatively, the lower end of the closure 31 may be connected by a hinge (not shown) to the housing. The tabs 38 and fixtures 40 cooperate with a latch 39 that engages the arcuate upper end of the closure 31. The closure 31 and cover 24 together form the back side 30 of the housing. The closure 31 is thus detachable or removable in the preferred embodiment, in order to access the player-receiving recess 8 and is fastened to the housing so as to retain the player 10.

Aspects of the present invention have been described by way of example only and it should be appreciated that modifications and additions may be made thereto without departing from the scope thereof.

1. A hand-held remote control for an entertainment appliance comprising;
a housing having a front side;
an electromagnetic radiation emitter disposed within the housing for emitting a control signal recognizable by the entertainment appliance;
a first keyboard having a plurality of manually depressible function keys located on the front side;
a printed circuit board positioned inside the housing, the printed circuit board being responsive to contact with at least one of the manually depressible function keys for correspondingly actuating the electromagnetic radiation emitter;
a recess in the housing for receiving a portable media player;
a first interface device within the recess, wherein the portable media player includes a second interface device such that the first and second interface devices communicate with each other when the portable media player is received in the recess, and
an electromagnetic radiation transmitter disposed within the housing for transmitting data received from the first interface device.

2. The remote control of claim 1 wherein the housing is elongate, the recess having a mouth at a longitudinal end of the housing, the portable media player being moved substantially in a length-wise direction relative to the housing when inserted or removed from the recess.

3. The remote control of claim 2 wherein the front side is planar and the recess has an axis substantially parallel to the front side.

4. The remote control of claim 3 wherein the recess has an inner end bounded by opposing front and back walls, joined by opposing side walls, the front side being an outwardly facing side of the front wall, an outer end of the recess being bounded by the back wall, the side walls, and a lip fixed to each side wall extending generally parallel to the back wall.

5. The remote control of claim 4 wherein the mouth includes a concave portion extending between the lips.

6. The remote control of claim 1 wherein the interface devices are embodied as electrical contacts.

7. The remote control of claim 1 wherein the electromagnetic radiation emitter comprises an infrared LED.

8. The remote control of claim 1 wherein the electromagnetic radiation transmitter comprises a radio transmitter.

9. The remote control of claim 1 further comprising a closure for closing the recess to retain the portable media player.

10. The remote control of claim 9 wherein an aperture is provided in the closure for providing the user with access to controls on the the portable media player.

11. The remote control of claim 10 wherein the closure is detachably mounted to the housing.

12. A system for remotely controlling an entertainment appliance and remotely selecting media to play on the entertainment appliance from a portable media player, the system including a hand-held remote control for the entertainment appliance and a charging station, the hand-held remote control comprising:
a housing having a front side;
a compartment within the housing for receiving rechargeable batteries for powering the remote control;
an electromagnetic radiation emitter disposed within the housing for emitting a control signal recognizable by the entertainment appliance;
a first keyboard having a plurality of manually depressible function keys located on the front side;
a printed circuit board positioned inside the housing, the printed circuit board being responsive to contact with at least one of the manually depressible function keys for correspondingly actuating the electromagnetic radiation emitter;
a recess in the housing for receiving a portable media player;
a first interface device within the recess, wherein the portable media player includes a second interface device such that the first and second interface devices communicate with each other when the portable media player is received in the recess, and
an electromagnetic radiation transmitter disposed within the housing for transmitting data received from the first interface device as a data signal, and
the charging station, comprising:
an enclosure;
a cavity in the enclosure for receiving the remote control;
a mains power input;
a battery charger in the cavity, the battery charger connected to the power input for charging the batteries;
a receiver in the enclosure for receiving the data signal, and
an output electrically connected to the receiver for transmitting the data signal, whereby a connector coupling the output to an input on the entertainment appliance for receiving a signal from an external source, thereby allows the transmission of data from the media player to the entertainment appliance.
